(19) United States
(12) Patent Application Publication
(10) Pub. No.: US 2012/0318944 A1
(43) Pub. Date: Dec. 20, 2012

(54) RETAINER ASSEMBLY

(75) Inventors: Richard J. ERNST, San Diego, CA (US); John P. GRIMM, Santee, CA (US)

(73) Assignee: ILLINOIS TOOL WORKS INC., Glenview, IL (US)

(21) Appl. No.: 13/483,936

(22) Filed: May 30, 2012

Related U.S. Application Data
(60) Provisional application No. 61/498,699, filed on Jun. 20, 2011.

(51) Int. Cl. A47F 5/00; B65H 75/20; F16C 11/04

(52) U.S. Cl. 248/309.1; 403/119; 242/118.1

(57) ABSTRACT

A pivoting retainer that may be used by itself or in a plurality of applications may include a tab and a housing, the tab including a shaft configured to be received in a channel within the housing. A coupling device may be at an end of the shaft such as an expanding mushroom-type connection or a locking nut with a compression spring. The retainer may include a plurality of male detents and a second plurality of female detents to index the tab in a plurality of angular configurations about the housing. In one embodiment, the tab may include a plurality of flexing fins to provide a springing action to hold the male detents within respective female detents. Exemplary uses for pivoting retainer may include at the end of one or more arms of a cord-wrapping apparatus and at the end of one or more shelves or hooks for holding objects.

This application claims the benefit of priority from U.S. Provisional Application 61/498,699, filed Jun. 20, 2011.

### BACKGROUND

It may be convenient for a person to store various articles in different ways, e.g., to wrap cords up so that they are in a compact configuration, or to place a ladder on hooks installed on a wall so that it is out of the way. The storage device may move over time or allow the stored item to become loose, or the stored item itself may shift. While storing these items reduces clutter, it would be useful if the storage device does not allow for the stored item to fall or allow for unintended cluttering of the area around where it is stored.

Additionally, it sometimes can be awkward to store items, e.g., sometimes they are bulky or heavy. This may make both the initial storage of the object and the subsequent retrieval of the object for future use difficult or cumbersome.

What is needed is a storage solution that addresses the problems of the prior art.

### SUMMARY

The present disclosure is directed a pivoting retainer that may include a tab having an arm and a shaft; a housing having a channel configured to receive the shaft; the tab including a plurality of circumferentially spaced detents; and the housing including a plurality of circumferentially spaced mating detents. The detents disposed on the tab may comprise male detents, and the mating detents on the housing may comprise female detents, although the reverse is possible.

The tab also may include a retaining element at a distal end of the shaft. In one embodiment, the retaining element may comprise a plurality of tines having a split therebetween, wherein the housing comprises a lip proximate an exit of the channel, and wherein the tines are configured to engage the lip to retain the tab in a coupled configuration with the housing. In another embodiment, the retaining element may comprise a nut coupled to an end of the shaft.

The tab further may include a plurality of fins circumferentially spaced proximate a base of the shaft, there being a gap behind the fins. The fins may be configured to flex when the tab is rotated and the detents are separated from the mating detents. Fins further may be configured to return to a substantially unflexed configuration when the detents reengage the mating detents. In addition, the detents may be disposed on said plurality of fins, and the mating detents may be disposed on a flange within the channel. Moreover, there may be an unequal number of detents and mating detents.

In another embodiment, an apparatus for wrapping and retaining a cord may include a base having a center, a plurality of arms extending outward from the base, each arm having a proximal end proximate the base and a distal end opposite the proximal end; and a retainer at a distal end of each arm, the retainer having an initial configuration extending away from the center; wherein at least one retainer is pivotable from the initial configuration. This cord-wrap apparatus also may include a handle extending outward from the base, the handle disposed between the arms. Additionally, each arm further may include a shelf portion facing away from the center, wherein at least one retainer is pivotable to provide unimpeded access to the shelf in a direction generally aligned with the shelf. Moreover, a channel may be disposed beneath the shelf, where the retainer comprises a housing coupled within the channel.

In still another embodiment, a system for hanging objects may include: at least one base portion, a plurality of arms extending away from the at least one base portion, each arm having a proximal end proximate the at least one base portion and a distal end opposite the proximal end; and a retainer at a distal end of each arm, wherein each retainer is pivotable to provide generally unimpeded access to an upper surface of each arm in a direction generally aligned with each upper surface.

At least one arm may comprise a shelf and a plurality of braces below the shelf, there being a channel formed between the braces. Additionally, the retainer may comprise a tab having a shaft, and a housing having a channel configured to receive the shaft, where the channel is configured to receive the housing. At least one brace may include a slot, and the housing may include a tab, the tab configured to operatively engage the slot to couple the housing to the channel. Moreover, the tab may include a plurality of detents and the housing may include a plurality of mating detents, wherein the detents and mating detents index the tab in a plurality of circumferential configurations.

These and other features and advantages are evident from the following description, with reference to the accompanying drawings.

### BRIEF DESCRIPTION OF THE DRAWINGS

FIG. 1 is an exploded, perspective view of one embodiment of a pivoting retainer.

FIG. 2 is a reverse, perspective view of the retainer of FIG. 1.

FIG. 3 is a side view of the retainer of FIG. 1 in a coupled configuration.

FIG. 4 is a front view of the retainer of FIG. 3.

FIG. 5 is a side, section view through section B-B of FIG. 4.

FIG. 6 is a perspective view of the housing of the retainer of FIG. 1.

FIG. 7 is an exploded, perspective view of a second embodiment of a pivoting retainer.

FIG. 8 is a reverse, perspective view of the retainer of FIG. 7.

FIG. 9 is a side view of the retainer of FIG. 7 in a coupled configuration.

FIG. 10 is a front view of the retainer of FIG. 9.

FIG. 11 is a side, section view through section A-A of FIG. 10.

FIG. 12 is a perspective view of a cord wrapping apparatus including a pivoting retainer.

FIG. 13 is a perspective view of a system for holding objects including a plurality of pivoting retainers.

FIG. 14 is a perspective view of a second embodiment of a system for holding objects including a plurality of pivoting retainers.

FIG. 15 is a perspective view of a second embodiment of a cord wrapping apparatus including a pivoting retainer.

FIG. 16 is a second, rear perspective view of the cord wrapping apparatus of FIG. 15.

### DETAILED DESCRIPTION

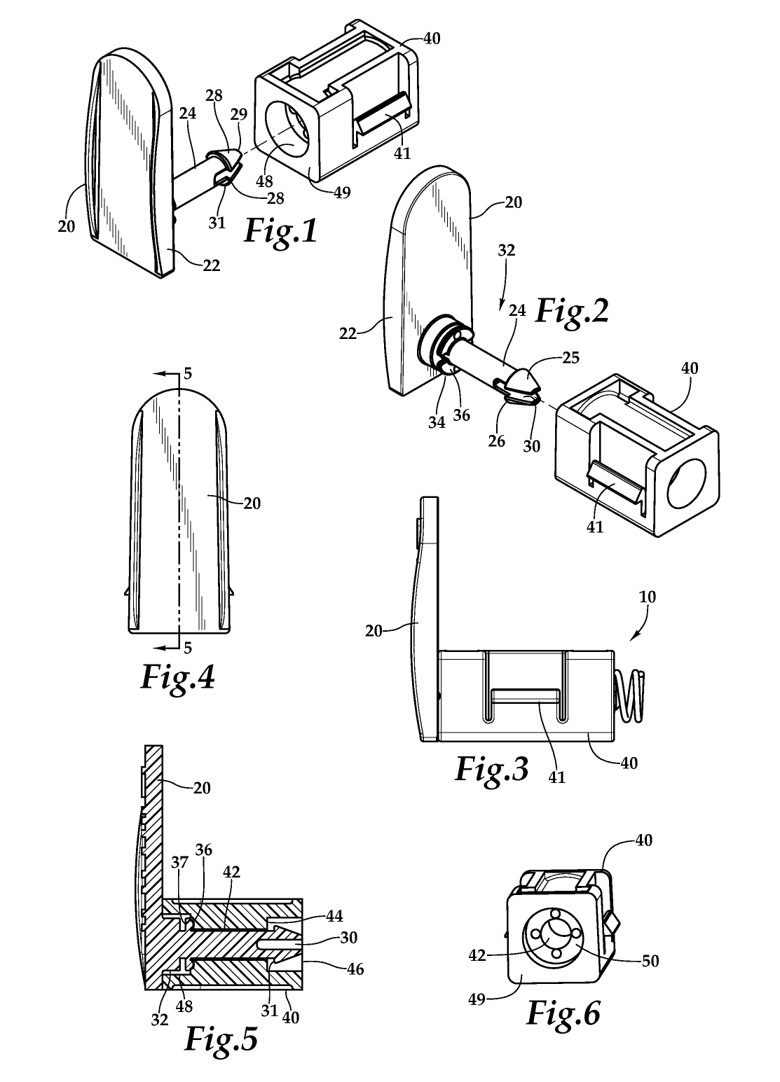

As seen in FIGS. 1-6, pivoting retainer 10 may include tab 20 rotatable with respect to housing 40. Tab 20 may include arm 22 pivotable between a retaining configuration and a releasing configuration. Tab 20 also may include shaft 24 insertable into channel 42 of housing 40. Both shaft 24 and channel 42 preferably may be substantially cylindrical, although shaft 24 and channel 42 may have any configuration that allows for rotation of shaft 24 relative to channel 42.

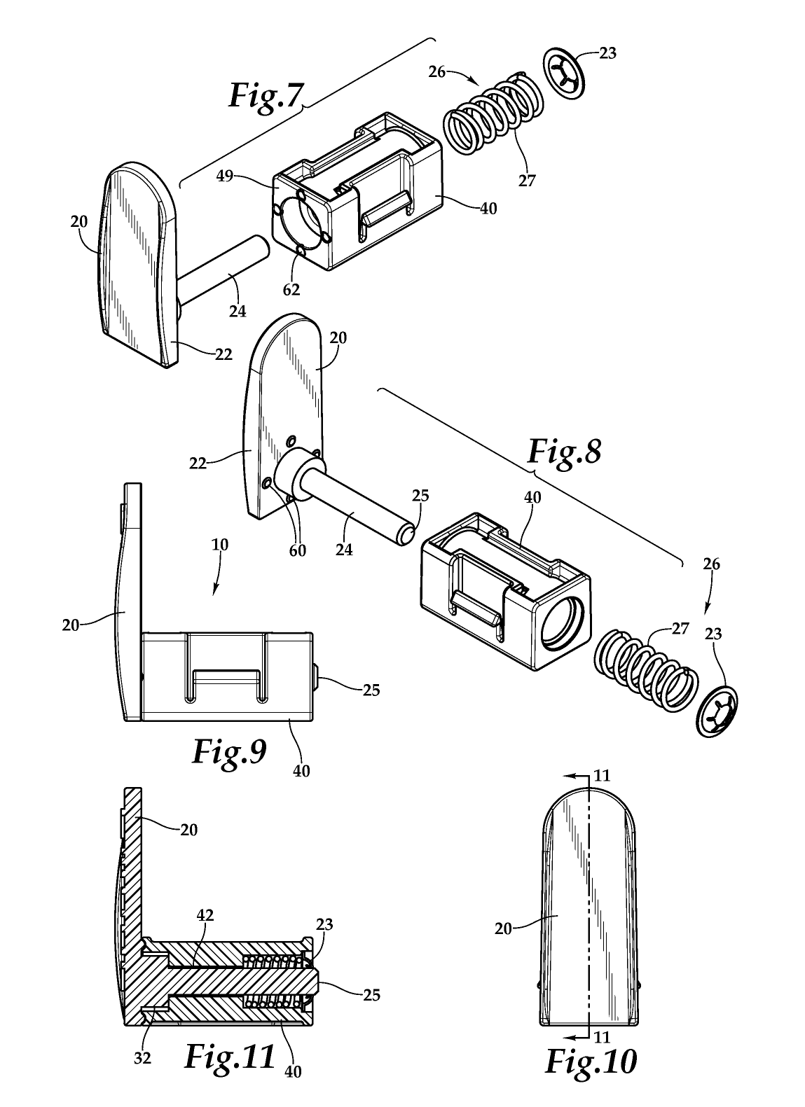

In one embodiment, end 25 of shaft 24 may terminate in a retaining element 26, so that tab 20 may be operatively coupled to housing 40. During use, retaining element 26 may keep tab 20 from moving laterally with respect to housing 40, although retaining element 26 may allow for separability of tab 20 from housing 40. For example, in the embodiment shown in FIGS. 7-11, retaining element 26 may include a washer or nut 23, e.g., a friction nut that couples to shaft 24 to prevent shaft 24 from backing out of housing 40. Retaining element 26 also may include compression spring 27 that bears against interior of housing 40, to assist in biasing tab 20 in one of a plurality of stop positions.

Returning to FIGS. 1-6, retaining element 26 preferably may be integrally formed with shaft, e.g., a plurality of tines 28 with a split 30 between tines 28. Split 30 may extend partially along length of tines, preferably along substantially the entire length of tines 28, and still further may extend beyond tines 28 into a portion of shaft 24. As such, split 30 may allow for compression of tines 28 when shaft is inserted into channel 42.

Tines 28 may expand radially outwardly from distal end 29 toward intersection with shaft 24. As shaft 24 progresses along channel 42, it eventually may encounter lip 44, i.e., a change in radial dimension from that of channel 42. Lip 44 may coincide laterally with an exit 46 of channel 42. Alternatively, lip 44 may appear as a step radially outward from the walls of channel 42, with another change in radial dimension experienced at exit 46. In these embodiments, maximum radial dimension of tines 28 may be larger than maximum radial dimension of channel 42 so that when tines 28 pass lip 44, split 30 may widen, which may separate tines 28, operatively coupling tab 20 to housing 40. Once separated, rear surface 31 of tines 28 may bear against lip 44 if an opposite lateral force is exerted on tab 20, preventing removal of tab 20 unless a user compresses tines 28 to provide sufficient clearance with lip 44.

Base 32 of shaft 24, i.e., the portion of shaft 24 proximate arm 22 may include a spring feature 34, which may be separate from shaft 24 but preferably is formed integrally with shaft 24. For example, shaft 24 may include one or more spring fins 36 disposed generally circumferentially about shaft 24, preferably a plurality of spring fins 36 generally equally circumferentially disposed about shaft 24.

Fins 36 may have a relatively small thickness, e.g., between about ¼ and about ½ as thick as larger diameter base 32 of shaft 24. There may be a gap 37 between fins 36 and a remainder of base 32, i.e., on the side of fins 36 nearer to arm 22. Gap 37 may have a thickness generally equal to thickness of fins 36.

Housing 40 may include entrance 48 at an end generally opposite from exit 46. Flange 50 may be proximate entrance 48, e.g., spaced laterally inward from entrance 48.

When tab 20 is operatively coupled to housing 40, arm 22 may be generally coincident with face 49 of housing proximate entrance 48. A thickness of entrance between face 49 and flange 50 may be substantially equal to, or slightly smaller than a distance from arm 22 to forward face of fins 36, which may result in a slightly compressive force being exerted by housing 30 on tab 20 to maintain arm 22 in a desired configuration.

Retainer 10 further may include one or more sets of male and female detents to provide rest positions for tab 20 and to index tab 20 in a predetermined number of incremental circumferential positions. Male detents 60 may be disposed on tab 20 and female detents on 62 may be disposed on housing 40, but a reverse configuration also is possible.

As seen in FIGS. 1-6, male detents 60 may be disposed on fins 36, and female detents 62 may be disposed on flange 50, inside housing 40. Detents 60, 62 may be located in other or additional areas. For example, as seen in the embodiment of FIGS. 7-8, male detents may be disposed around arm 22 while mating female detents 62 may be disposed on face 49 of housing 40.

As arm 22 is rotated, male detents 60 may push out of female detents 62 and rotate about housing until a new, respective set of female detents 62 are reached. Male detents 60 then drop into new set of female detents 62, holding arm 22 in the new configuration. In the embodiment of FIGS. 1-6, this may occur without tab 20 moving laterally relative to housing 40, because fins 36 may flex rearward into gap 37, releasing male detents from female detents. When new female detents are reached, fins 36 may spring back to original positions, opening up gap 37 and seating male detents.

Conversely, in the embodiment of FIGS. 7-10, tab 20 may move laterally away from housing 40 slightly, freeing male detents and compressing spring 27. When new female detents are reached, compression spring may return to its original position, holding male detents in new female detents.

Cord Wrap Embodiment

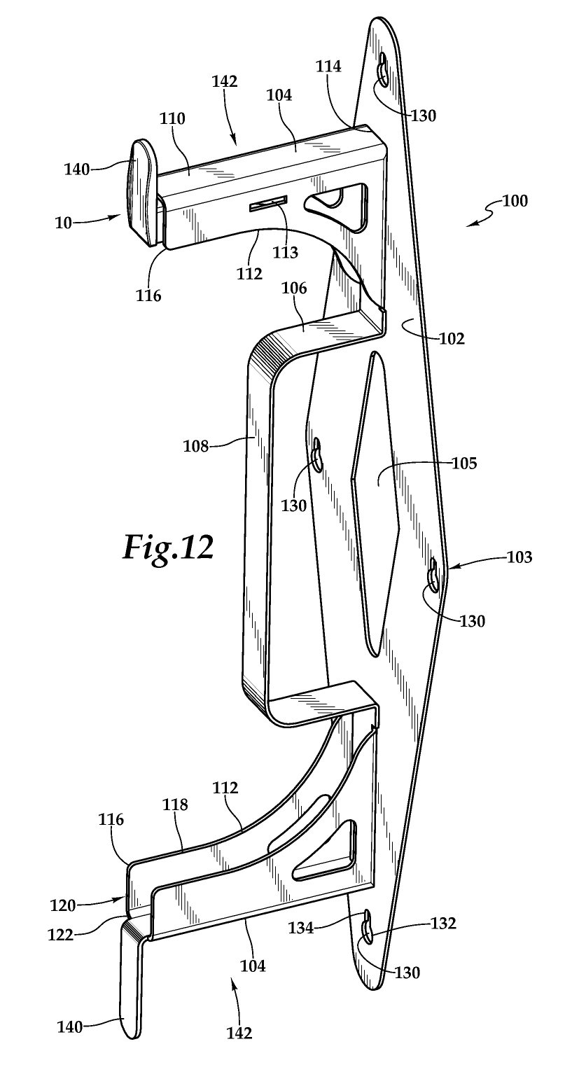

In one embodiment, as seen in FIG. 12, retainer 10 may be incorporated into an apparatus 100 for wrapping, retaining, and/or unwinding a body such as a cord, cable, hose, etc. For exemplary purposes only, wrapping apparatus may be referred to herein as a cord wrap 100. Cord wrap 100 may comprise base 102 and a plurality of arms 104 extending generally outward from base 102.

Cord wrap 100 preferably is sturdy, while remaining lightweight and simple to manufacture. For example, substantially all of cord wrap 100 may be made of a single type of material such as sheet metal. Base 102 may be a stamped, single sheet of sheet metal, whereas arms 104, handle 108, braces 112, and one or more of retainers 140 may be one or more pieces of sheet metal, which may be stamped to form openings, bent into desired configurations, and/or welded or otherwise coupled to itself to form various components.

Base 102 may include a plurality of openings 130, such as for receiving a plurality of fasteners to couple base 102 to a wall. Openings 130 may include a larger opening portion 132 below a smaller opening portion 134. Larger opening portion 132 may be sized to receive a head of a standard fastener. Smaller opening portion 134 may be smaller than fastener head, but still sized to receive the shank of a fastener. As such, when coupling base 102 to wall, larger opening portions 132 may pass around fastener heads, then base 102 may be lowered, allowing fastener shanks to bear on smaller opening portions.

Openings 130 may be located on base so as to provide for easy installation of fasteners in wall and for distributed loading of base. For example, a first plurality of openings may be substantially vertically aligned, and a second plurality of openings may be substantially horizontally aligned. Thus, a user may need to know only the distance between openings and then install fasteners in the wall in a level configuration to ensure that openings 130 will align with installed fasteners.

At least a portion 103 of base may extend out laterally wider than the rest of base 102, which may increase stability of base 102 against the wall, thereby leading to less movement of cord wrap 100 during wrapping and unwrapping. Base 102 also may include an opening 105, which may be located between arms 104 and underneath handle 108, discussed below.

As seen in FIG. 12, both base 102 and opening 105 may be generally diamond-shaped, although one or both of base 102 and opening 105 may be shaped differently.

Between arms 104, apparatus 100 may include a flange 106 separated from base 102, so as to form a handle 108 for cord wrap 100. Handle 108 may extend outward a smaller amount than arms 104, which may reduce the amount of material necessary to form cord wrap 100 while increasing the relative surface area available for holding cord.

Each arm 104 may include a shelf portion 110 against which cord may bear when wrapped. Shelf portion 110 may have any configuration that allows for wrapping and retention of cord. For example, each shelf portion 110 may be substantially planar and may have a thickness generally equal to thickness of handle 108. Here, shelf portion 110 may lie in a plane substantially perpendicular to base 102, although shelf portion alternatively may be angled acutely or obtusely with respect to base 102. In still another configuration, shelf portion may be generally convex, which may increase the amount of available surface area against which cords may bear.

Each arm 104 further may include one or more braces 112, which may extend from proximal end 114 proximate base 102 outward toward distal end 116. When moving from distal end 116 toward proximal end 114, brace 112 may extend away from shelf 110 an increasing amount, i.e., a distance between shelf 110 and a bottom portion 118 of brace 112 may be smaller near distal end 116 than near proximal end 114. Brace 112 further may include a void 120 near proximal end 114, which may allow brace to retain rigidity and strengthening properties while reducing weight and the amount of material required to form cord wrap 100.

While one brace 112 on each arm 104 may be sufficient, cord wrap 100 preferably includes a plurality of braces for each arm 104, e.g., two braces 112, one on each side of shelf portion 110, so as to form a channel 122 underneath shelf portion 110 and between braces 112.

At least one, and preferably both, of arms 104 may include a retainer 140 extending away from distal ends 116 of arms. Retainers 140 may extend away from a center of base 102 to form a second plurality of channels 142, which may be bounded on a plurality of sides and preferably may be open on at least one side, although channels 142 may be fully bounded, provided they form an opening large enough for cord to pass through for winding and unwinding. As seen in FIG. 12, channels 142 may be bounded on three sides by base 102, shelf portions 110 of arms 104, and retainer 140.

One of retainers may be fixedly mounted or coupled to arm 104 and/or shelf 110. For example, retainer 140 may be integrally formed with shelf 110.

Additionally, at least one of retainers 140 may be substantially similar to pivoting retainer 10 described above. Here, housing 40 may be configured to fit within channel 122 under shelf portion 110 formed by braces 112. One or more of braces 112 may include a slot 113 or other opening that may be configured to couple with one or more tabs 41 extending outward from housing 40.

When coupled to braces 112, retainer may be substantially fixedly mounted, while still permitting rotation of arm 22.

Storing cable may involve winding the cord around arms 104 repeatedly until an end of cord is reached or a desired amount of cord is wound. At any point in time before, during, or after winding, arm 22 may be rotated away from other arm 104, forming channel 142 to prevent movement of wound cord away from base 102. When cable removal is desired, arm 104 may be rotated at least about 90 degrees in either direction and preferably up to about 180 degrees. In any of these configurations, channel 142 may disappear and no impediment may remain along length of shelf 110. As such, a plurality of cord windings may be removed from cord wrap 100 at a single time.

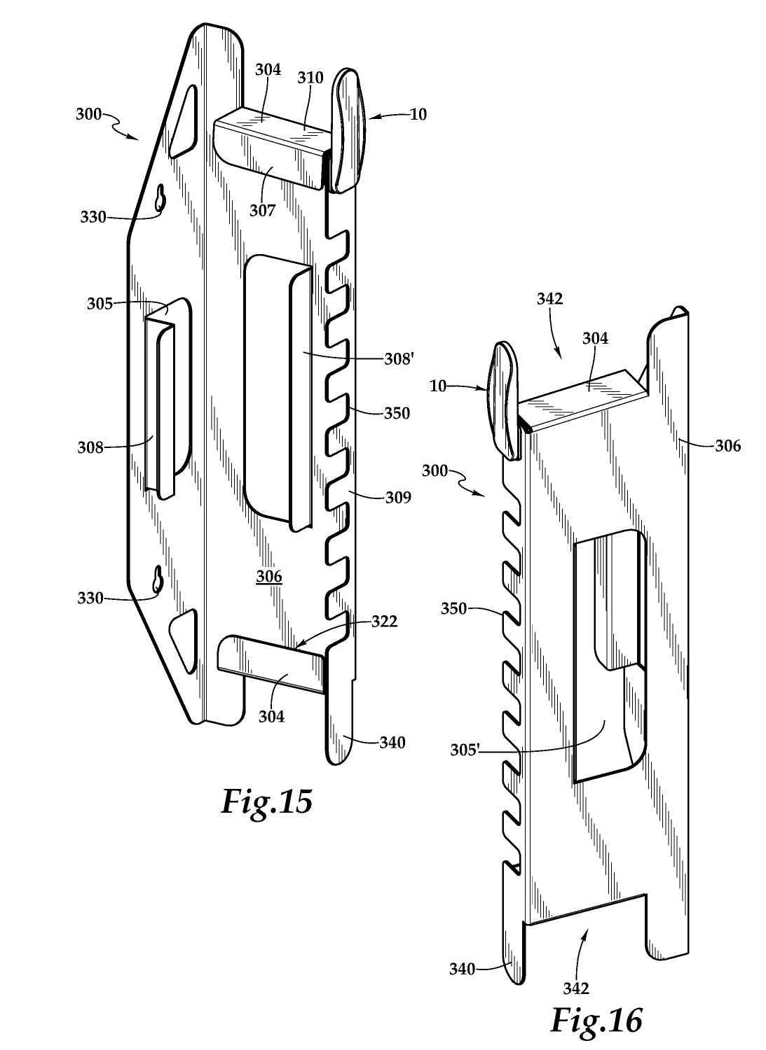

Turning to FIGS. 15-16, a second cord wrap 300 embodiment is shown. In this embodiment, cord wrap 300 may include a base 302 having openings 330 configured to receive fasteners so as to releasably mount cord wrap 300 to a wall. Cord wrap 300 may include a panel 306 extending away from base 302, preferably along one side of base 302. In addition, cord wrap also may include a flange 309 extending at an opposite side of panel 306. Base 302 and flange 309 may be substantially parallel to one another, and panel 306 may be substantially perpendicular to at least one of base 302 and flange 309.

Base 302 may include an opening 305, and material from opening 305 may be used to form a first handle 308. For example, instead of completely separating material when forming opening, material at one edge of opening 305 may be retained and bent away from base. This material may be bent a second time, forming handle 308. As such, handle 308 may have a first component proximate base 302 that is substantially perpendicular to base 302 and a second component that is substantially parallel to base and that extends away from opening 305. In use, the user then may grip the base 302 and the substantially parallel portion of handle 308 in order to carry cord wrap 300.

Similarly, panel 306 may include a second opening 305′, and material from second opening 305′ may be used to form second handle 308′. This material may be bent inward at the edge of opening 305′ closer to flange 309, which may cause handle 308′ to extend substantially parallel to flange 309. Thus, the user may grip both handle 308′ and flange 309 in order to carry cord wrap 300.

An arm 304 may be disposed proximate at least one, and preferably both, of an upper and lower end of panel 306. Arm 304 may extend inwardly from panel 306, between base 302 and flange 309. Arm 304 may comprise a shelf portion 310, which preferably is substantially perpendicular to panel 306, and a second portion 307, which may be substantially perpendicular to shelf portion 310 and substantially parallel to panel 306.

As seen in FIGS. 15 & 16, arm 304 may be formed from panel material by bending a portion of panel inward, resulting in formation of channel 342, which may extend inward from the top or bottom edge of panel 306. Channel 342 may be bounded by edge of panel 306 and/or base 302 on one side and retainer 340 at an opposite side.

As with cord wrap 100, in cord wrap 300, at least one retainer 340 may comprise retainer 10, where housing 40 is disposed within channel 322 formed by arm 304. One retainer 304 alternatively may be fixed, e.g., formed as an end of flange 309.

Cord wrap 300 further may include one or more scallops 350 formed inward along an edge of flange 309. Scallops 350 may be sized and otherwise configured to receive plugs at each end of a cord. For example, to wrap cord, a first plug may be inserted within one of scallops 350. Cord then may be wrapped around arms 304 and flange until a second end of cord is reached, with the second plug being inserted into another scallop 350. During this process, retainer 10 may be rotated toward flange 309 to form an opening into channel 342. Alternatively, retainer 10 may be rotated away from flange to form a side of channel 342, and cord may be wrapped through the top opening of channel 342.

In order to remove cord, retainer 10 may be rotated toward flange 309, opening channel in the direction away from base 302. If cord ends are held within scallops 350, these also may be removed. Wrapped cord then may be slid off arm 304 and, once free, out of channel 342 proximate 340. As such, the user may remove the entire cord (or a desired portion) without the need to unravel the cord to do so.

Ladder Hook Embodiment

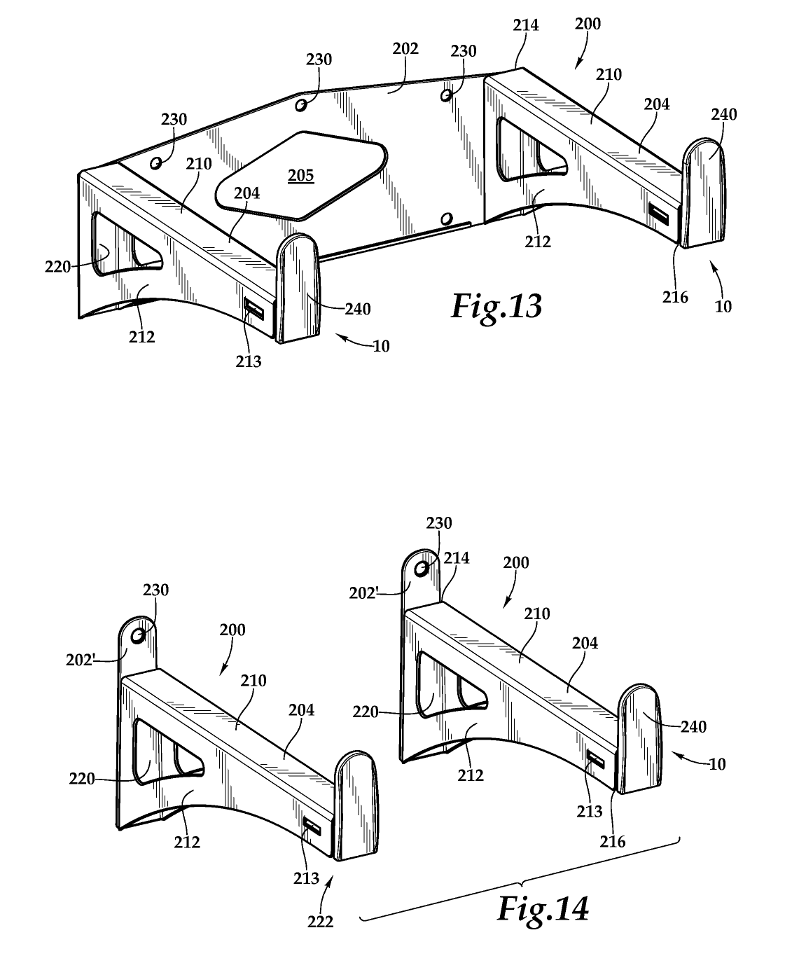

In a second embodiment, as seen in FIGS. 13-14, retainer 10 may be incorporated into one or more hooks 200 for storing objects such as ladders, chairs, pipes, lumber, etc. For the sake of convenience only, these are described herein as ladder hooks 200.

Ladder hooks 200 may include a base 202, with a plurality of arms 204 extending outward therefrom. In one embodiment, as seen in FIG. 13, a plurality of arms 204 may be coupled via a shared base 202, and in a second embodiment, as seen in FIG. 14, arms 204 each may include their own base 202′.

When hooks share a base 202, that base 202 may span the distance between arms 204 and further may include an opening 205 between arms 204. As seen in FIG. 13, both base 202 and opening 205 may be generally diamond-shaped, although one or both of base 202 and opening 205 may be shaped differently. Base 202 also may include a plurality of openings 230 configured to receive fasteners for mounting base 202 to a wall.

When hooks each have their own base 202′, each base 202′ may extend behind a respective arm 204 and above that arm 204. At least one opening 230 may be disposed in the portion of base 202′ above arm 204, which may increase a shear component of loading on fastener caused by loading on arm 204, thereby increasing an overall holding strength of hook 200.

Arms 204 of ladder hooks 200 may be similar to arms 104 of cord wrap 100, i.e., each arm 204 may include a shelf portion 210 that may have any configuration that allows for storage and retention of items. For example, each shelf portion 210 may be substantially planar.

Shelf portions 210 may be substantially level, providing for level storage of ladder or other objects resting on shelf portions 210. Thus, shelf portions 210 may lie in a plane substantially perpendicular to base 202, although shelf portion alternatively may be angled acutely with respect to base 202, which may bias object to be stored toward wall.

Each arm 204 further may include one or more braces 212, which may extend from proximal end 214 proximate base 202 outward toward distal end 216. When moving from distal end 216 toward proximal end 214, brace 212 may extend away from shelf 210 an increasing amount, i.e., a distance between shelf 210 and a bottom portion 218 of brace 212 may be smaller near distal end 216 than near proximal end 214. Brace 212 further may include a void 220 near proximal end 214, which may allow brace to retain rigidity and strengthening properties while reducing weight and the amount of material required to form ladder hook 200.

While one brace 212 on each arm 204 may be sufficient, ladder hook 200 preferably includes a plurality of braces for each arm 204, e.g., two braces 212, one on each side of shelf portion 210, so as to form a channel 222 underneath shelf portion 210 and between braces 212.

At least one, and preferably both, of arms 204 may include a retainer 240 extending upward from distal ends 216 of arms. Retainers 240 may prevent objects from sliding off shelf portions 210 and onto the floor or other objects that may be located near where ladder hooks 200 are mounted, e.g., a user's vehicle if hooks are mounted in a garage.

One of retainers 240 may be fixedly mounted or coupled to arm 204 and/or shelf 210. For example, retainer 240 may be integrally formed with shelf 210. Preferably, however, each retainer 240 may be substantially similar to pivoting retainer 10 described above. Here, housing 40 may be configured to fit within channel 222 under shelf portion 210 formed by braces 212. One or more of braces 212 may include a slot 213 or other opening that may be configured to couple with one or more tabs 41 extending outward from housing 40.

When coupled to braces 212, retainer 240 may be substantially fixedly mounted, while still permitting rotation of arm 22.

Storing ladders or other objects may involve rotating retainer 240 downward at least about 90 degrees so that arm 22 may not inhibit access to shelf 210. While rotating arm 22 out of the way may save only a slight amount of height necessary for raising the object to be placed on shelf portion 210, the object may be heavy or awkward to handle so this height savings may be useful to the user. Additionally, once a portion of the object is placed on shelf portion 210, the user may be able to slide the remainder of the object onto the shelf portion instead of having to attempt to maneuver all of it up and over retainers 240. Then, once the object is loaded sufficiently, arms 22 may be rotated back until at least a portion of arm 22 extends upward past distal end 216 of shelf portion and, preferably, until arm 22 is substantially vertical.

Like cord wrap 100, ladder hooks 200 preferably are sturdy, while remaining lightweight and simple to manufacture. For example, substantially all of ladder hooks 200 may be made of a single type of material such as sheet metal. Base 202 may be a stamped, single sheet of sheet metal, whereas each arm 204 with its respective braces 212 may be one or more pieces of sheet metal, which may be stamped to form openings, bent into desired configurations, and/or welded or otherwise coupled to itself to form various components.

It should be appreciated that retainer 10 may be used in a variety of applications in which placing arm 22 in a retaining configuration may inhibit movement of one or more objects, whereas converting arm 22 into releasing configuration may allow for easier removal, translation, or other relative movement of those objects.

While the foregoing written description of the invention enables one of ordinary skill to make and use what is considered presently to be the best mode thereof, those of ordinary skill will understand and appreciate the existence of variations, combinations, and equivalents of the specific exemplary embodiment and method herein. The invention should therefore not be limited by the above described embodiment and method, but by all embodiments and methods within the scope and spirit of the invention as claimed.

What is claimed is:

1. A pivoting retainer, comprising:
a tab having an arm and a shaft;
a housing having a channel configured to receive said shaft;
said tab including a plurality of circumferentially spaced detents; and
said housing including a plurality of circumferentially spaced mating detents.

2. A pivoting retainer according to claim 1, wherein said detents disposed on said tab comprise male detents and said mating detents on said housing comprise female detents.

3. A pivoting retainer according to claim 1, said tab further including a retaining element at a distal end of said shaft.

4. A pivoting retainer according to claim 3, said retaining element comprising a plurality of tines having a split therebetween,
wherein said housing comprises a lip proximate an exit of said channel, and
wherein said tines are configured to engage said lip to retain said tab in a coupled configuration with said housing.

5. A pivoting retainer according to claim 3, said retaining element comprising a nut coupled to an end of said shaft.

6. A pivoting retainer according to claim 3, further comprising a spring coupled between and bearing against said retaining element and an interior of said housing.

7. A pivoting retainer according to claim 1, said tab further comprising a plurality of fins circumferentially spaced proximate a base of said shaft, there being a gap behind said fins.

8. A pivoting retainer according to claim 7, wherein said fins are configured to flex when said tab is rotated and said detents are separated from said mating detents and further configured to return to a substantially unflexed configuration when said detents reengage said mating detents.

9. A pivoting retainer according to claim 7, wherein said detents are disposed on said plurality of fins, and said mating detents are disposed on a flange within said channel.

10. A pivoting retainer according to claim 1, wherein said detents are disposed on said arm, and said mating detents are disposed on an external face of said housing.

11. A pivoting retainer according to claim 1, further comprising an unequal number of detents and mating detents.

12. An apparatus for wrapping and retaining a cord, comprising:
a base having a center,
a plurality of arms extending outward from said base, each arm having a proximal end proximate said base and a distal end opposite said proximal end; and
a retainer at a distal end of each arm, said retainer having an initial configuration extending away from said center;
wherein at least one retainer is pivotable from said initial configuration.

13. An apparatus according to claim 12, further comprising a handle extending outward from said base, said handle disposed between said arms.

14. An apparatus according to claim 12, each arm further comprising a shelf portion facing away from said center, wherein at least one retainer is pivotable to provide unimpeded access to said shelf in a direction generally aligned with said shelf.

15. An apparatus according to claim 12, further comprising a channel disposed beneath said shelf, wherein said retainer comprises a housing coupled within said channel.

16. A system for hanging objects comprising:
at least one base portion,
a plurality of arms extending away from said at least one base portion, each arm having a proximal end proximate said at least one base portion and a distal end opposite said proximal end;
a retainer at a distal end of each arm, wherein each retainer is pivotable to provide generally unimpeded access to an upper surface of each arm in a direction generally aligned with each said upper surface.

17. A system according to claim 16, wherein at least one arm comprises a shelf and a plurality of braces below said shelf, there being a channel formed between said braces.

18. A system according to claim 17, said retainer comprising a tab having a shaft and a housing having a channel configured to receive said shaft;
wherein said channel is configured to receive said housing.

19. A system according to claim 18, wherein at least one brace includes a slot and said housing includes a tab, said tab configured to operatively engage said slot to couple said housing to said channel.

20. A system according to claim 18, said tab including a plurality of detents and said housing including a plurality of mating detents, wherein said detents and said mating detents index said tab in a plurality of circumferential configurations.
